(19) United States
(12) Patent Application Publication
(10) Pub. No.: US 2013/0323525 A1
(43) Pub. Date: Dec. 5, 2013

(54) REFRACTORY INTERFACE COATING FOR BI-METALLIC AUTOMOTIVE PRODUCTS AND METHOD

(71) Applicants: Silviu A. Popescu, Ajax (CA); Richard M. Kleber, Clarkston, MI (US); James A. Webster, Shelby Township, MI (US); Mark T. Riefe, Brighton, MI (US); Tomasz Warzecha, Sterling Heights, MI (US); David Begleiter, Toronto (CA)

(72) Inventors: Silviu A. Popescu, Ajax (CA); Richard M. Kleber, Clarkston, MI (US); James A. Webster, Shelby Township, MI (US); Mark T. Riefe, Brighton, MI (US); Tomasz Warzecha, Sterling Heights, MI (US); David Begleiter, Toronto (CA)

(73) Assignee: GM GLOBAL TECHNOLOGY OPERATIONS LLC, Detroit, MI (US)

(21) Appl. No.: 13/487,670

(22) Filed: Jun. 4, 2012

(51) Int. Cl. B32B 3/06; F16D 65/12; B60B 35/00; B22D 19/16

(52) U.S. Cl. 428/596; 164/75; 188/218 XL; 301/124.1; 280/80.1; 428/66.2

(57) ABSTRACT

An automotive product having a plurality of components coated with a refractory interface coating and method for making the same are provided. The automotive product may include at least a first component and a second component configured to interconnect and engage one another. The first component may be composed of a first high-density material. The second component may be formed of a second lower-density material. A refractory interface coating may be applied at the interconnection between the first and second components to provide an enhanced surface finish to limit friction, prevent metallurgical bonding between the first material and second material, provide a barrier against galvanic corrosion, and provide a thermal barrier between the first component and second component to guard against thermal deformation or change in dimension of the second component.

### TECHNICAL FIELD

This disclosure relates to a refractory interface coating applied to bi-metallic components of an automotive product.

### BACKGROUND

Automotive products including, but not limited to, brake rotors, pulleys, brake drums, and transmission gears, may have a plurality of components composed of different materials that are interconnected. The components may be interconnected by a cast-in-place process, in which one component is cast over the other component to form a joint or interconnection.

During vehicle operation, thermal expansion and contraction may occur, as the temperature of each of the components may rise to an increased operating temperature during vehicle operation and fall to a decreased resting temperature during vehicle rest. The increase in temperature during vehicle operation may lead to thermal deformation and degradation of both the yield strength and tensile strength of the materials.

### SUMMARY

An automotive product having a plurality of components coated with a refractory interface coating is provided. The automotive product may include at least a first component and a second component.

The first component may be composed of a first high-density material. The first component may include an annular portion and a first flange member. The first flange member may include a first surface and a second surface and may be configured to extend radially from the annular portion. A plurality of mechanical engagement features may be formed upon and extend from the first surface and second surface of the first flange member.

The second component may be formed of a second lower-density material. The second component may include a hub portion and a second flange member. The second flange member may be configured to engage the first flange member at an interface with the plurality of mechanical engagement features, forming an interconnection between the first and second components. The second component may be integrally formed onto the first component in a cast-in-place or other process known in the art.

A refractory interface coating may be applied to the plurality of mechanical engagement features to improve the interface between the first and second components by providing an enhanced surface finish to limit friction, prevent metallurgical bonding between the first material and second material, provide a barrier against galvanic corrosion, and provide a thermal barrier between the first component and second component to guard against thermal deformation or change in dimension of the second component.

A method for making a bi-metallic automotive product is also provided. The method includes the steps of forming a first component utilizing a casting, machining, forging, or other suitable metal working process; applying a refractory interface coating to the plurality of mechanical engagement features of the first component; placing the first component in a first cavity of a molding machine; and injecting molten material into the cavity to envelop the first plurality of mechanical engagement features, thereby casting the second component about the first component.

The above features and advantages, and other features and advantages, of the present invention are readily apparent from the following detailed description of some of the best modes and other embodiments for carrying out the invention, as defined in the appended claims, when taken in connection with the accompanying drawings.

### BRIEF DESCRIPTION OF THE DRAWINGS

FIG. 1 is a schematic, perspective view of an example embodiment of the first component.

FIG. 2 is a schematic, perspective view of an example embodiment of the product showing the interconnection of the first and second components.

FIG. 3 is a schematic, segmented, perspective, cross-sectional view of an example embodiment of the first component.

FIG. 4 is a schematic, segmented, perspective, cross-sectional view of an example embodiment of the interconnection of the first component and second component.

### DETAILED DESCRIPTION

Those having ordinary skill in the art will recognize that terms such as “above,” “below,” “downward,” “upward,” “top,” bottom,” etc., are used descriptively for the figures, and do not represent limitations on the scope of the invention. The following description and Figures refer to example embodiments and are merely illustrative in nature and not intended to limit the invention, its application, or uses.

Referring to the Figures, wherein like reference numbers correspond to like or similar components throughout the several views, an automotive product 100 having a plurality of components 101, 102, which may be coated with a refractory interface coating 104 is provided. The automotive product 100 may include, but is not limited to, applications including brake rotors, a pulley, a sprocket, brake drums, transmission gears, or transmission gear assemblies. An example of the automotive product 100, is generally shown as a brake rotor assembly in FIG. 2 at 100. The automotive product 100 generally comprises a first component 101 and a second component 102.

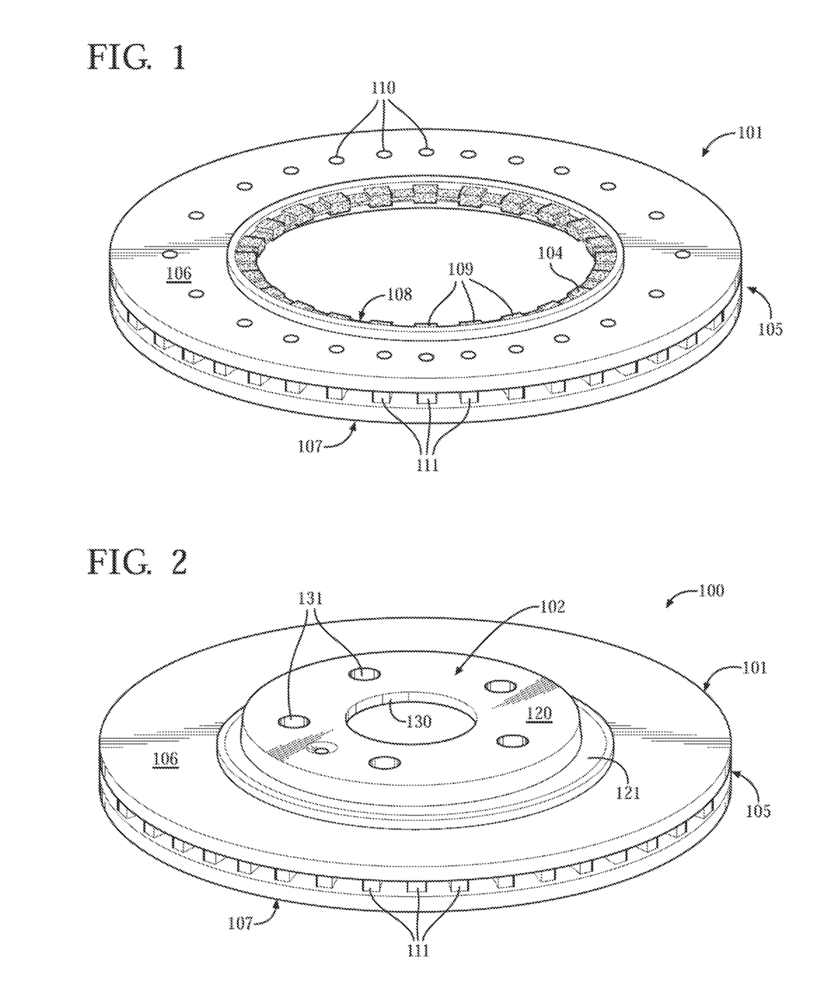

Generally, referring to FIGS. 1-4, an example automotive product 100 may include a brake rotor assembly, which may be formed by a cast-in-place process or another similar process known in the art. The first and second components 101, 102 are joined at an interconnection 103. The interconnection 103 may be coated with a refractory interface coating 104, discussed in more detail herein below. The refractory interface coating 104 may be configured to improve the interface of the first and second components 101, 102 by providing an enhanced surface finish to limit friction, prevent metallurgical bonding between the first material and second material, provide a barrier against galvanic corrosion, and provide a thermal barrier between the first component 101 and second component 102 to guard against thermal deformation or change in dimension of the second component 102.

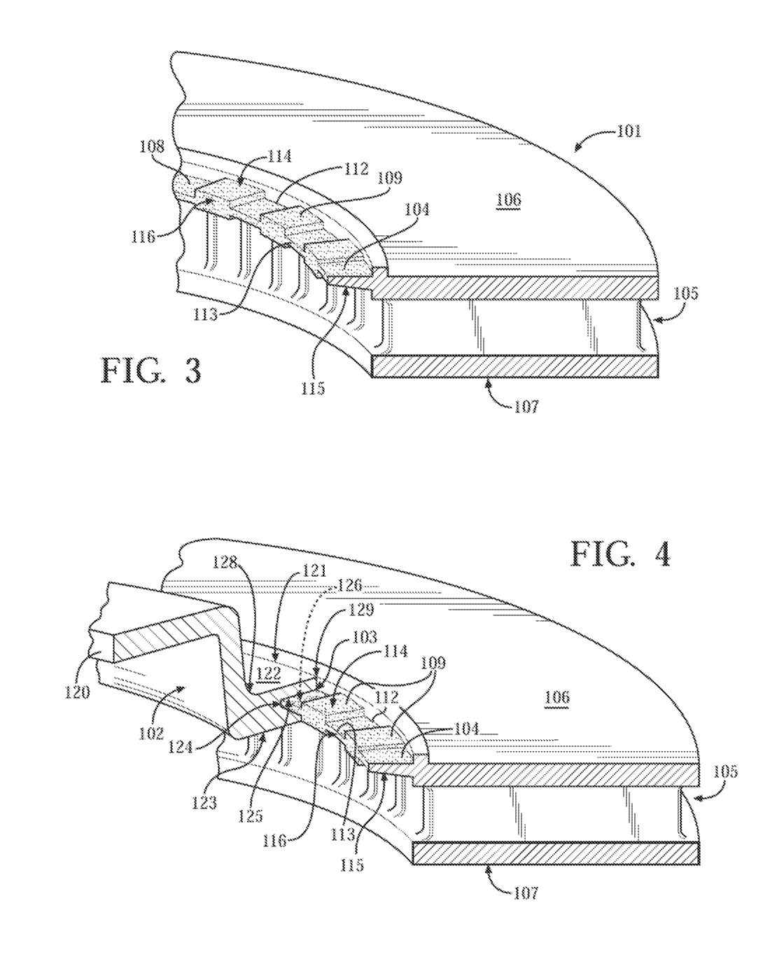

Referring to FIGS. 1 and 3, the first component 101 may be composed of a first high-density material, which may provide resistance to thermal deformation and may resist wear, such as cast-iron, steel, or the like. The first component 101 may include an annular portion 105, which may be of the vented-type having a plurality of vanes 111, or may be of the solid, non-vented type (not shown). The annular portion 105 may be further configured to have a first friction surface 106 and an opposite second friction surface 107. The first friction surface 106 may be separated from the second friction surface 107 by the plurality of vanes 111, in a vented example embodiment. Together the first and second friction surfaces 106, 107 form the braking surfaces 106, 107 of the example brake rotor assembly 100 that come into contact with the brake pad (not shown) during a vehicle braking event. The first and second frictional surfaces 106, 107 may each respectively define a plurality of through holes 110 configured to allow the escape of heat generated during a vehicle braking event.

The first component 101 may further include a first flange member 108. The first flange member 108 may be configured to extend radially from the first friction surface 106 and annular portion 105. The first flange member 108 may be configured to extend from a first flange proximal end 112, proximate the first friction surface 106, to a first flange distal end 113. The first flange member 108 may be further configured to have a first surface 114, a second surface 115, and an inner surface 116. The inner surface 116 may further be formed at the first flange distal end 113. A plurality of mechanical engagement features 109, such as teeth or the like, may be formed on and protrude from the first surface 114 and the second surface 115. The plurality of mechanical engagement features 109 may be equally spaced or randomly staggered circumferentially, upon the first flange member 108. The plurality of mechanical engagement features 109 may be configured to engage the second component 102.

Referring to FIGS. 2 and 4, the second component 102 may be formed of a second lower-density material or composite, and may be configured to reduce the weight of the automotive product 100. The second lower density material or composite may include, but is not limited to Aluminum, Magnesium, or another lower-density material or composite. The second component 102 may include a hub portion 120 and a second flange member 121. The hub portion 120 may include features to attach the brake rotor assembly 100 to a vehicle axle assembly (not shown) such as a central bore 130 and a plurality of bolt holes 131. The second flange member 121 may be configured to extend radially from the hub portion 120. The second flange member may extend from a second flange proximal end 128, proximate the hub portion 120, to a second flange free end 129. The second flange member 121 may further include at least two second flange surfaces 122, 123.

An engagement slot 124 may be defined by the second flange member 121 between the at least two second flange surfaces 122, 123. The engagement slot 124 may include a first engagement slot surface 125 and a second engagement slot surface 126. The second flange member 121 may be configured to engage and trap the first flange member 108 within the engagement slot 124, forming an interconnection 103 between the first component 101 and the second component 102. The interconnection 103 of the first component 101 and second component 102 may be formed with the plurality of mechanical engagement features 109 and the engagement slot 124 to limit the rotation of the second component 102 relative to the first component 101 during vehicle operation. The second component 102 may be integrally formed onto the first component 101 in a cast-in-place process or other process known in the art.

Referring generally to FIGS. 1-4, the plurality of mechanical engagement features 109 may be coated with a refractory interface coating 104. The refractory interface coating 104 may be a blend of refractories designed for coating molten Aluminum, Magnesium, Iron, or steel, such as a ceramic coating or the like. Example refractory interface coatings 104 are commercially available from Southeastern Foundry Products & Foundry Coatings, Inc. of Alabaster, Ala. Available example coatings include, but are not limited to, those designated as: High Temp Ladle Kote 310B; High Temp Ladle Kote 315; High Temp Ladle Kote 315A; High Temp Ladle Kote 410; High Temp Ladle Kote 500; High Temp Ladle Kote 512. Suitable refractory interface coatings 104 may be configured to maintain a viscosity of about 3000 cP to about 4000 cP when measured using a Brookfield Viscometer Spindle #3 or #4 at 20 RPM. For example, High Temp Ladle Kote 310B; High Temp Ladle Kote 315; and High Temp Ladle Kote 315A are configured to maintain a viscosity of about 3000 cP to about 4000 cP when measured using a Brookfield Viscometer Spindle #4 at 20 RPM; High Temp Ladle Kote 410; High Temp Ladle Kote 500; High Temp Ladle Kote 512 are configured to maintain a viscosity of about 3000 cP to about 4000 cP when measured using a Brookfield Viscometer Spindle #3 at 20 RPM. The refractory interface coating 104 may be applied at the interconnection 103 between the first component 101 and second component 102 by a brushing process, spraying process, or another suitable method of application known in the art.

Generally, in bi-metallic automotive product applications, heat transfer from the first and second frictional surfaces 106, 107 of the first component 101 of a first high-density material, to the second component 102, of a lower-density material can cause the second component 102 to deform, change dimension, and degrade at temperatures above about 150° C. The temperature at the interconnection 103 between the first component 101 and second component 102 can reach temperatures in excess of about 200° C., during vehicle operation. Thus, the application of a refractory interface coating 104 at the interconnection 103 between the first component 101 and the second component 102, for example, at the plurality mechanical engagement features 109, may absorb heat generated by the application of the brake pads (not shown) to the first and second friction surfaces 106, 107 of the first component 101. The refractory interface coating 104 may limit heat transfer from the first component 101 to the second component 102, thereby functioning as a thermal barrier, which may allow the second lower-density material of the second component 102 to maintain dimension, yield strength, tensile strength, and elongation during vehicle operation.

The application of a refractory interface coating 104 at the interconnection 103 between the first component 101 and the second component 102 may also provide several other advantages to bi-metallic automotive products 100. The application of the refractory interface coating 104 may enhance the surface finish of each of the respective first and second components 101, 102, which may limit friction at the interface between the first component 101 and the second component 102 at the interconnection 103, and provide a barrier against galvanic corrosion.

An additional advantage of applying the refractory interface coating 104 at the interconnection 103 between the first component 101 and the second component 102 may be the prevention or limiting of metallurgical bonding between the first high-density material of the first component 101 and second lower-density material of the second component 102.

A method for making a bi-metallic automotive product 100 is also provided. The method includes the steps of forming a first component 101 utilizing a casting, machining, forging, or other suitable metal working process; applying a refractory interface coating 104 at the interconnection 103 between the first component 101 and a second component 102; placing the first component 101 in a first cavity of a molding machine; and injecting molten material into the cavity to envelop the first plurality of mechanical engagement features 109 thereby casting the second component 102 about the first component 101.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1. An automotive product comprising:
a first component of a first material including:
an annular portion having at least one friction surface,
a first flange member having a first surface and a second surface, the first flange member configured to extend radially from the at least one friction surface of the annular portion,
a plurality of mechanical engagement features that protrude and extend from the first surface and the second surface;
a second component, of a second material, configured to engage the first flange member; and
wherein the first flange member and the plurality of mechanical engagement features are coated with a refractory interface coating.

2. The automotive product of claim 1 wherein the first material has a greater density than the second material.

3. The automotive product of claim 2 wherein the first material is cast-iron and the second material is at least one of Aluminum and Magnesium.

4. The automotive product of claim 1 wherein the refractory interface coating is a ceramic coating.

5. The automotive product of claim 1 wherein the refractory interface coating has a viscosity from about 3000 cP to about 4000 cP.

6. The automotive product of claim 1 wherein the first flange member further includes a first flange proximal end and a first flange distal end, the first flange member configured to extend radially from the at least one friction surface of the annular portion from the first flange proximal end to the first flange distal end.

7. The automotive product of claim 1 wherein the second component includes:
a hub portion;
a second flange member having at least two second flange surfaces, a second flange proximal end and a second flange free end, the second flange member configured to extend radially from the hub portion from the second flange proximal end to the second flange free end;
an engagement slot defined by the second flange member between the at least two second flange surfaces, the engagement slot having an first engagement slot surface and a second engagement slot surface; and
wherein the engagement slot is configured to engage and receive the first flange member.

8. The automotive product of claim 7 wherein the hub portion defines at least one central bore hole and a plurality of bolt holes.

9. A vehicle comprising:
an automotive product including:
a first component of a first material including:
an annular portion having at least one friction surface,
a first flange member having a first surface, a second surface, first flange proximal end and a first flange distal end, the first flange member configured to extend radially from the annular portion, from the first flange proximal end to the first flange distal end,
a plurality of mechanical engagement features that protrude and extend from the first surface and the second surface;
a second component of a second material configured to engage the first flange member; and
wherein the plurality of mechanical engagement features are coated with a refractory interface coating;
a vehicle axle assembly configured to receive and engage the automotive product.

10. The vehicle of claim 9 wherein the second component includes:
a hub portion;
a second flange member having at least two second flange surfaces, a second flange proximal end and a second flange free end, the second flange member configured to extend radially from the hub portion from the second flange proximal end to the second flange free end;
an engagement slot defined by the second flange member between the at least two second flange surfaces, the engagement slot having an first engagement slot surface and a second engagement slot surface; and
wherein the engagement slot is configured to engage and receive the first flange member.

11. The vehicle of claim 10 wherein the automotive product is a brake rotor assembly.

12. The vehicle of claim 9 wherein the first material has a greater density than the second material.

13. The vehicle of claim 12 wherein the first material is cast iron and the second material is at least one of Aluminum and Magnesium.

14. The vehicle of claim 9 wherein the refractory interface coating is a ceramic coating.

15. The vehicle of claim 9 wherein the refractory coating has a viscosity from about 3000 cP to about 4000 cP.

16. A method of making an automotive product, the method comprising:
forming a first component, of a first material, utilizing a metal working process, the first component having a plurality of mechanical engagement features;
applying a refractory interface coating to the plurality of mechanical engagement features of the first component;
placing the first component in a molding machine cavity;
creating a second component, of a second material, by injecting molten material into the molding machine cavity to envelop the plurality of engagement features;
forming an interconnection between the first and second components upon cooling of the molten material.

17. The method of claim 16 wherein the first material has a greater density than the second material.

18. The method of claim 17 wherein the first material is cast iron and the second material is at least one of Aluminum and Magnesium.

19. The method of claim 16 wherein the refractory interface coating is a ceramic coating.

20. The method of claim 16 wherein the refractory interface coating has a viscosity from about 3000 cP to about 4000 cP.
